(19) United States
(12) Patent Application Publication
(10) Pub. No.: US 2008/0189627 A1
(43) Pub. Date: Aug. 7, 2008

(54) Execution of application based on task selection

(75) Inventors: Egor Nikitin, Bellevue, WA (US); Mukesh Karki, Issaquah, WA (US); Narayanan Parthasarathy, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/703,510

(22) Filed: Feb. 7, 2007

(51) Int. Cl. G06F 3/048

(52) U.S. Cl. 715/762

(57) ABSTRACT

When a processing device is started, configuration information may be automatically examined to determine applications for performing a number of tasks. As a result, a user interface including selectable task-focused user interface (UI) elements may be displayed to a user. The selectable task-focused UI elements may be orb-shaped and displayed in a circular pattern at about a middle portion of a display screen. Each of the selectable task-focused UI elements may include a description of a corresponding task. When the user selects one of the selectable task-focused UI elements, a corresponding application may be executed to perform the corresponding task. In some embodiments, selectable category-focused UI elements may be displayed based on the automatically examined configuration information. Selection of one of the selectable category-focused UI elements may cause at least one selectable task-focused UI element corresponding to the selected one of the selectable category-focused UI elements to be displayed.

### BACKGROUND

A user of a processing device such as, for example, a personal computer (PC), typically, is presented with a menu or a display of user interface (UI) elements including a representation of a number of applications which can be used to perform a number of tasks. With respect to some processing devices, a command line or other non-graphical interface may be provided for a user to enter a name of an application, which the user desires to be executed. However, a beginning user of the processing device may be overwhelmed by a quantity of the UI elements presented or, with respect to a provided non-graphical interface, may be overwhelmed and may not understand what application name to enter. Further, the user also may not understand which applications to use to perform certain tasks. For example, the beginning user may not know what application to use to prepare a report for school, what application to use to perform a search on the Internet, what application to use to create or view a spreadsheet, or what application to use to send and receive e-mail messages. The problem, for example, could be a poor product name, or a poorly described product function. Further, the beginning user may not understand what an operating system can do and may get confused or distracted by pop-ups, notifications, windows, balloons, tool tips, etc, effectively making task completion difficult or impossible.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a graphical user interface, including a number of selectable task-focused user interface (UI) elements, may be presented to a user of a processing device. In some embodiments, the task-focused UI elements may be orb-shaped and displayed in a circular pattern at about a middle portion of a display screen. Each of the selectable task-focused UI elements may include text describing a corresponding task. When the user selects one of the selectable task-focused UI elements, a corresponding application may be executed to perform the corresponding task. In one embodiment, when the application is launching, an orb-shaped representation of the application might minimize to a certain area on the screen, into a certain portion of the UI (i.e. system tray, Start button, icon, etc), or may disappear/close completely.

When the processing device starts up, configuration information may be automatically examined to determine applications for performing a number of tasks. The displayed task-focused UI elements may be based on the automatically examined configuration information.

In some embodiments, selectable category-focused UI elements may be displayed based on the automatically examined configuration information. Each of the selectable category-focused UI elements may describe a corresponding category of tasks. When the user selects one of the selectable category-focused UI elements, the processing device may display at least one selectable task-focused UI element corresponding to the selected one of the selectable category-focused UI elements.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 a functional block diagram illustrating an exemplary processing device, which may be used in implementations consistent with the subject matter of this disclosure.

FIG. 2 illustrates an exemplary graphical user interface including category-focused user interface (UI) elements.

FIGS. 3-5 illustrate exemplary graphical user interfaces including task-focused UI elements, which may be displayed as a result of selecting one of the category-focused UI elements of FIG. 2.

FIG. 6A illustrates an exemplary graphical user interface including a number of task-focused UI elements corresponding to common tasks, which may be executed by a processing device in an embodiment consistent with the subject matter of this disclosure.

FIG. 6B illustrates the exemplary graphical user interface of FIG. 6A after a pointer is moved closer to a task-focused user interface element, in one embodiment consistent with the subject matter of this disclosure.

FIGS. 7-8 are flowcharts illustrating exemplary processing which may be performed by a processing device in an embodiment consistent with the subject matter of this disclosure.

FIG. 9 illustrates an exemplary hierarchy of file extensions, which may be traversed in an embodiment consistent with the subject matter of this disclosure.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Overview

In embodiments consistent with the subject matter of this disclosure, a user of a processing device may be presented with an interface including a number of task-focused user interface (UI) elements. In one implementation, the task-focused UI elements may be orb-shaped UI elements labeled by task, rather than by application name. The orb-shaped UI elements may be displayed in a circular pattern in about a middle portion of a display screen. In order to eliminate clutter and to focus attention of the user on the orb-shaped UI elements, a background portion of the display screen may be dimmed.

When the processing device starts up, the processing device may automatically examine configuration information to determine applications for performing a number of tasks. Corresponding task-focused UI elements may then be displayed, each of which may indicate a task linked to an application such as, for example, create a document, create a spreadsheet, open e-mail, browse Internet, open media player, games, as well as other or different tasks, including, but not limited to tasks linked to the control of the Task Launcher (Minimize, Close, etc). The user may select one of the task-focused UI elements corresponding to a desired task. As a result of the selection, an application for performing the desired task may be executed.

In some implementations, after selection of one of the task-focused UI elements, the task-focused UI elements may be minimized and a representation of the minimized task-focused UI elements may be moved and placed at a location of the display screen near a UI element used by more advanced users such as, for example, a Start button usually appearing at a lower left portion of the display screen, or other UI element.

Further, in some implementations the displayed UI elements may be category focused. For example, a number of category-focused UI elements may be displayed in an approximate circular configuration at about a middle portion of the display screen. Each category-focused UI element may represent a category of tasks. For example, the UI elements may represent categories such as, for example, entertainment, Internet & communications, documents, as well as additional or different categories. Selection by the user of one of the UI elements representing a desired category may result in a number of corresponding task-focused UI elements being displayed on the display screen. The user may then select one of the corresponding task-focused UI elements in order to execute an application to accomplish a desired task.

### Exemplary Processing Device

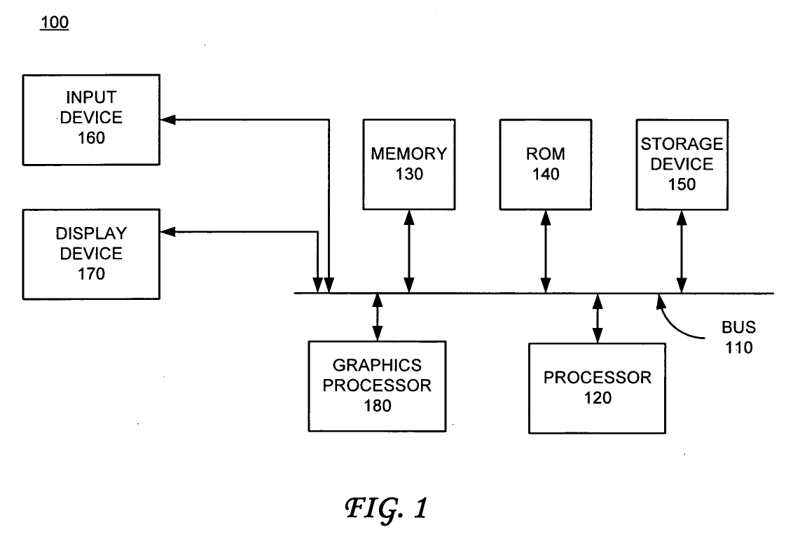

FIG. 1 is a functional block diagram that illustrates an exemplary processing device 100, which may be used to implement embodiments consistent with the subject matter of this disclosure. Processing device 100 may include a bus 110, a processor 120, a memory 130, a read only memory (ROM) 140, a storage device 150, an input device 160, and an output device 170. Bus 110 may permit communication among components of processing device 100.

Processor 120 may include at least one conventional processor or microprocessor that interprets and executes instructions. Memory 130 may be a random access memory (RAM) or another type of dynamic storage device that stores information and instructions for execution by processor 120. Memory 130 may also store temporary variables or other intermediate information used during execution of instructions by processor 120. ROM 140 may include a conventional ROM device or another type of static storage device that stores static information and instructions for processor 120. Storage device 150 may include any type of media for storing data and/or instructions.

Input device 160 may include one or more conventional mechanisms that permit a user to input information to processing device 100, such as, for example, a keyboard, a mouse, or other input device. Output device 170 may include one or more conventional mechanisms that output information to the user, including a display, or other output device.

Processing device 100 may perform such functions in response to processor 120 executing sequences of instructions contained in a tangible machine-readable medium, such as, for example, memory 130, or other medium. Such instructions may be read into memory 130 from another machine-readable medium, such as storage device 150, or from a separate device via a communication interface (not shown).

### Exemplary Display Screens

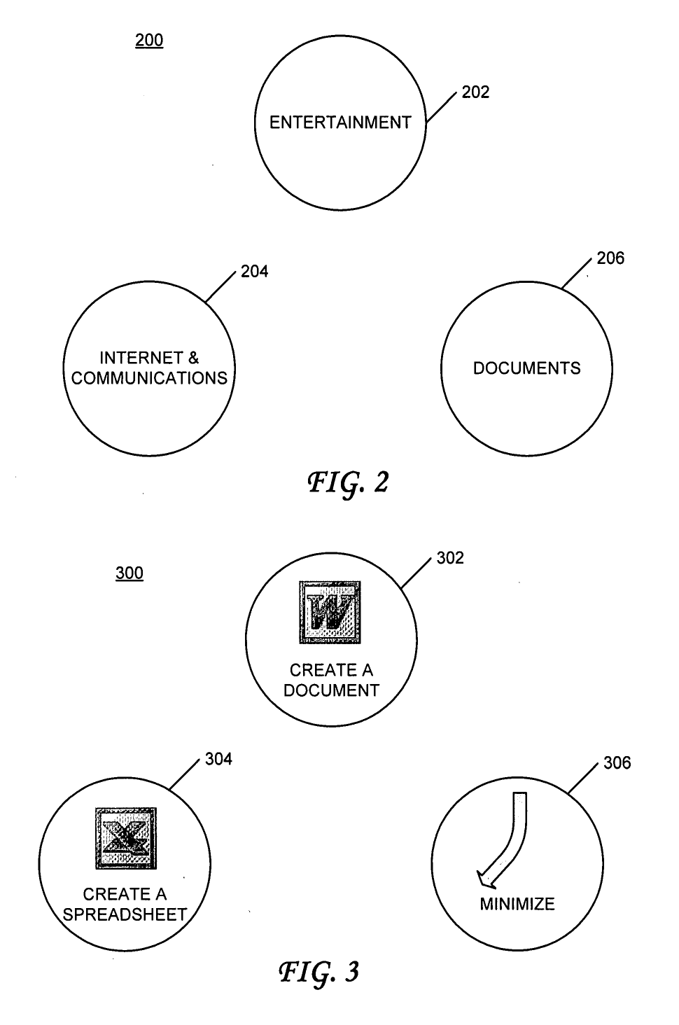

FIG. 2 illustrates an exemplary display screen 200, which may be displayed in an embodiment consistent with the subject matter of this disclosure. Upon startup of a processing device, such as, for example, processing device 100, the processing device may display a number of user interface (UI) elements. The UI elements may be category-focused UI elements. In this embodiment, the category-focused UI elements may be circular or orb-shaped and may be displayed in an approximate circular configuration about a middle portion of a display screen. In other embodiments, the category-focused UI elements may have a shape other than circular or orb-shaped. Each of the category-focused UI elements may include text describing a corresponding category of tasks which a user may perform using the processing device. In this embodiment, the category-focused UI elements may include an entertainment UI element 202, an Internet & communications UI element 204, and a documents UI element 206. In other embodiments, additional or other category-focused UI elements may be displayed.

In order to focus a user's attention on the category-focused UI elements, in some embodiments, the processing device may cause a background portion of display 200 to be dimmed, thereby highlighting the displayed category-focused UI elements. A user may select one of the category-focused UI elements corresponding to a desired task by using a pointing device, such as, for example, a computer mouse, a touchpad, an electronic stylus or a user's finger on a touch screen, or other device.

After selection of one of the category-focused UI elements, the processing device may cause one or more task-focused UI elements, corresponding to the selected one of the category-focused UI elements, to be displayed. In one embodiment, the one or more task-focused UI elements may be circular or orb-shaped and may be displayed in an approximate circular configuration about a middle portion of a display screen. In other embodiments, the task-focused UI elements may have a shape other than circular or orb-shaped. Each of the task-focused UI elements may include text describing a task, which a user may perform using the processing device.

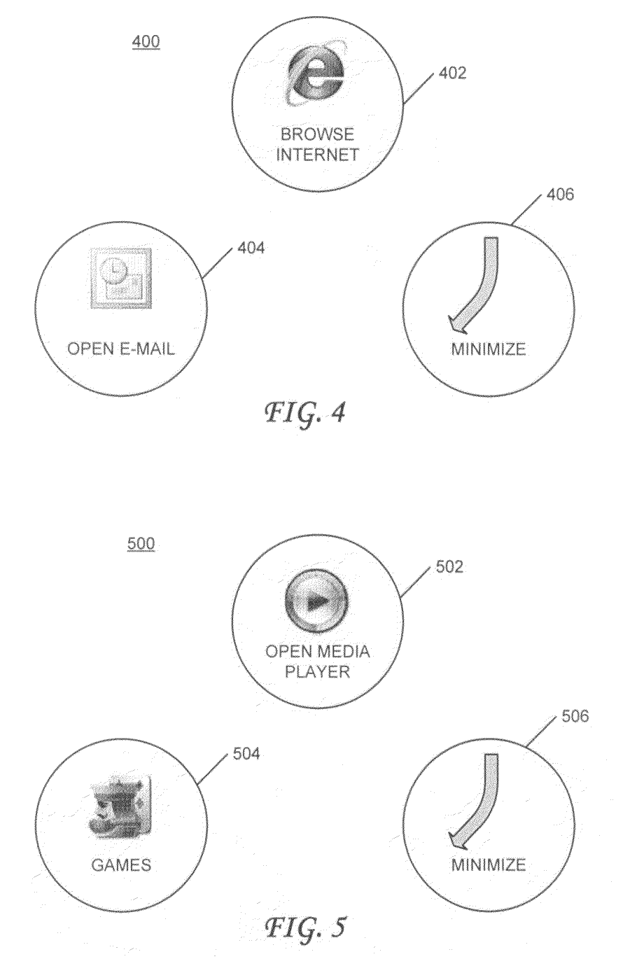

FIG. 3 illustrates an exemplary display screen 300, which may be displayed in an embodiment consistent with the subject matter of this disclosure when a user selects documents UI element 206 from exemplary display screen 200. After selection of documents UI element 206, the processing device may cause create a document task-focused UI element 302 and create a spreadsheet task-focused UI element 304 to be displayed, as well as a minimize UI element 306. The displayed UI elements of FIG. 3 may be circular or orb-shaped and may be displayed in an approximate circular configuration at about a middle portion of display screen 300. In other embodiments, the displayed UI elements may have other shapes. Further, UI elements 302 and 304 may include an icon associated with a corresponding application for performing a corresponding task. UI element 306 may also include an icon, which may represent a minimization operation.

In order to focus a user's attention on the task-focused UI elements, in some embodiments, the processing device may cause a background a portion of display screen 200 to be dimmed, thereby highlighting the displayed task-focused UI elements. A user may select one of the task-focused UI elements corresponding to a desired task by using a pointing device, such as, for example, a computer mouse, a touchpad, an electronic stylus or a user's finger on a touch screen, or other device.

Upon selection of one of task-focused UI elements 302 and 304 or minimize UI element 306, task-focused UI elements 302 and 304 and minimize UI element 306 may be minimized by the processing device and a minimized representation of the UI elements may be moved to a portion of the display screen near a user interface element used by more experienced users. For example, in one embodiment, in which a version of a Windows® operating system, available from Microsoft Corporation of Redmond, Wash., may be executing on the processing device, the minimized representation of the UI elements may be moved to a lower left portion of a display screen where a UI element, represented by a START button, may be displayed. Such a movement may cause a user, such as an inexperienced user, to get used to focusing on a UI element, such as, for example, the START button, or other UI element, as would a more experienced user.

Further, after selection of one of the task-focused UI elements, an application corresponding to the selected one of the task-focused UI elements may be executed by the processing device. For example, upon selection of task-focused UI element 302, a word processor, such as, for example, Microsoft Office Word, available from Microsoft Corporation of Redmond, Wash., or another word processor may be executed.

FIG. 3 illustrates a display screen in one exemplary embodiment. In another embodiment, the displayed task-focused UI elements may not include text describing a corresponding task. In one embodiment, the displayed task-focused UI elements may include large icons, or animated icons to convey to the user the task associated with the task-focused UI elements. For example, in one embodiment, a task-focused UI element may display an image of a pen moving across a notepad to convey that the task-focused UI element is associated with launching an application for creating a document. Further, in another embodiment, UI elements may appear as semi-transparent glass orbs, which may include a textual description, a large icon, an animated icon, or other indicator or descriptor of a task associated with an application to be launched when the corresponding one of the UI elements is selected by the user.

FIG. 4 illustrates an exemplary display screen 400, which may be displayed in an embodiment consistent with the subject matter of this disclosure when category-focused UI element 204 (Internet & communications) may be selected in exemplary display screen 200. Exemplary display screen 400 may include task-focused UI elements 402 and 404 for browsing the Internet and opening e-mail, respectively. Minimize UI element 406 may function in a same manner as previously described with respect to minimize UI element 306 (FIG. 3). Upon selection of task-focused UI element 402 or task-focused UI element 404, the processing device may cause the task-focused UI elements 402 and 404 and minimize UI element 406 to be minimized, in a manner as described with respect to FIG. 3, and the processing device may execute an application for performing a task corresponding to the selected task-focused UI element.

FIG. 5 illustrates an exemplary display screen 500, which may be displayed in an embodiment consistent with subject matter of this disclosure when category-focused UI element 202 (Entertainment) may be selected in exemplary display screen 200. Exemplary display screen 500 may include task-focused UI elements 502 and 504 for opening a media player and opening a game, respectively. Minimize UI element 506 may function in a same manner as previously described with respect to minimize UI element 306 (FIG. 3). Upon selection of task-focused UI element 502 or task-focused UI element 504, the processing device may cause the task-focused UI elements 502 and 504 and minimize UI element 506 to be minimized, in a manner as described with respect to FIG. 3, and the processing device may execute an application for performing a task corresponding to the selected task-focused UI element.

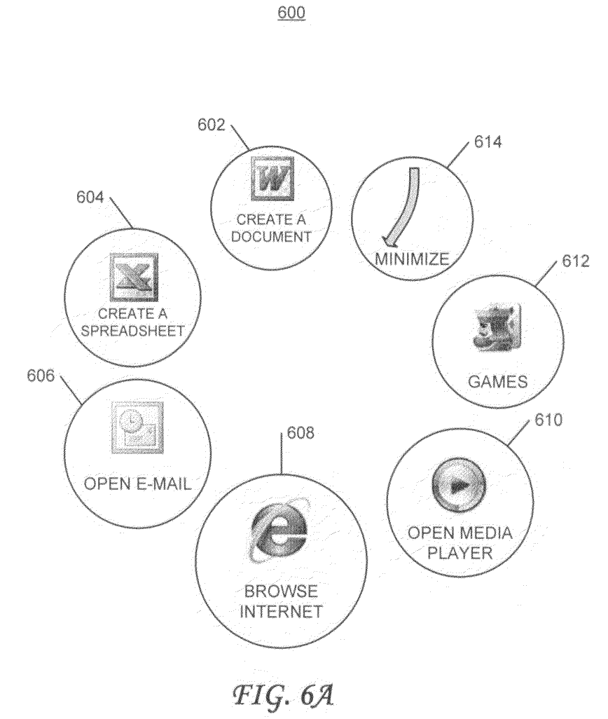

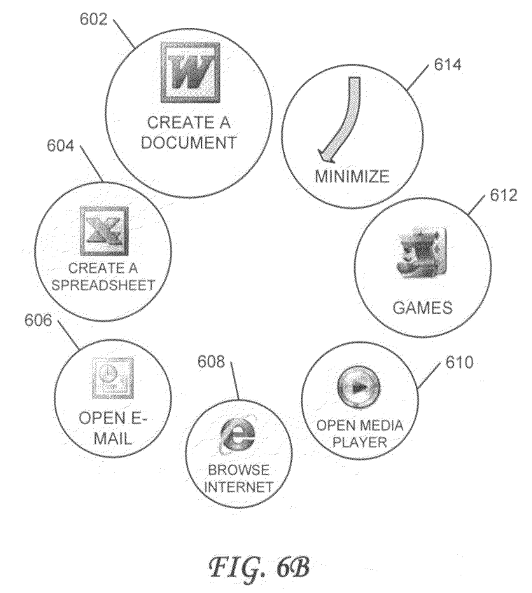

In some embodiments consistent with the subject matter of this disclosure, upon startup of a processing device, such as, for example, processing device 100, the processing device may automatically read or obtain configuration information to determine installed applications for performing various tasks. After determining which of the installed applications may perform various tasks and icons corresponding to the applications, the processing device may display a task-focused user interface. FIG. 6A illustrates an exemplary display screen 600, which the processing device may cause to be displayed in such an embodiment.

In exemplary display screen 600, a number of task-focused UI elements may be displayed. For example, display screen 600 may include a create a document UI element 602, a create a spreadsheet UI element 604, an open e-mail UI element 606, a browse Internet UI element 608, an open media player UI element 610, a games UI element 612, and a minimize UI element 614. Each of task-focused UI elements 602-612 may include text describing a corresponding task and may include an icon associated with an application for performing a corresponding task. Minimize UI element 614 may include an icon representative of a minimization operation.

In this embodiment, UI elements 602-614 may be circular or orb-shaped and may be displayed in an approximate circular configuration about a middle portion of a display screen. In some embodiments, UI elements may be displayed with 3-dimensional (3D) effects. For example, the displayed UI elements 602-614 may be displayed, such that, for example, UI elements 602-614 may appear to be tilted. In such an embodiment, UI elements appearing in one portion of the display screen, such as, for example, a bottom portion of the display screen, may appear to be closer to a user viewing the display screen than other UI elements. In other embodiments, UI elements 602-614 may have a shape other than circular or orb-shaped and/or the UI elements may be displayed in a configuration other than an approximate circular configuration. For example, in one embodiment, displayed UI elements may appear as rectangular tiles arranged in multiple rows and columns. Of course, the displayed UI elements may appear in numerous configurations in different embodiments.

In some embodiments, the processing device may cause a background portion of display 600 to be dimmed, thereby highlighting displayed UI elements 602-614. A user may select one of task-focused UI elements 602-612 corresponding to a desired task by using a pointing device, such as, for example, a computer mouse, a touchpad, an electronic stylus or a user's finger on a touch screen, or other device.

In one embodiment, as a pointer moves closer to a UI element, a configuration of the displayed UI elements may appear to tilting, such that a UI element closest to the pointer may appear closest to a user viewing the display screen. FIG. 6B illustrates a displayed configuration of the UI elements appearing tilted and UI element 602 appearing closest to the user viewing the display screen as the pointer moves close to UI element 602.

Upon selection of one of task-focused UI elements 602-612 or minimize UI element 614, UI elements 602-614 may be minimized by processing device and a minimized representation of the UI elements may be moved to a portion of the display screen near a user interface element used by more experienced users, such as, a START button, or other UI element as described previously.

Further, after selection of one of task-focused UI elements 602-612, an application corresponding to the selected one of the task-focused UI elements 602-612 may be executed by the processing device. For example, upon selection of task-focused UI element 602, a word processor, such as, for example, Microsoft Office Word, available from Microsoft Corporation of Redmond, Wash., or another word processor may be executed.

### Exemplary Processing

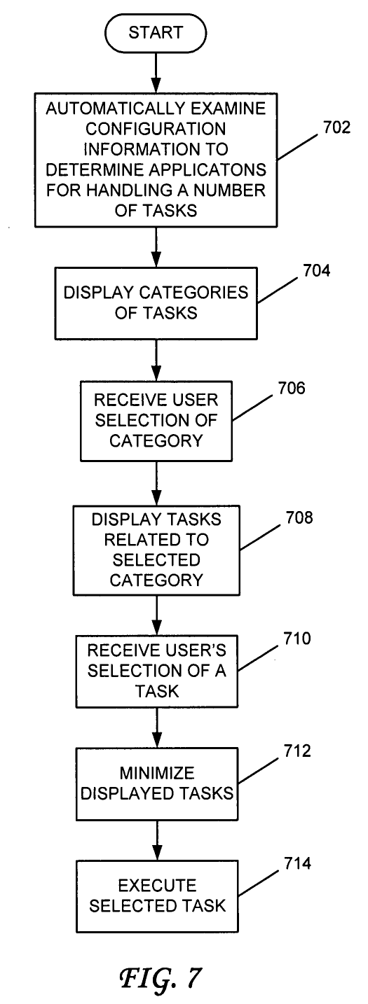

FIG. 7 is a flowchart illustrating an exemplary process which may be performed by embodiments consistent with the subject matter of this disclosure. The process may begin with a processing device, such as, for example, processing device 100, starting up and automatically examining configuration information to determine various applications and associated icons for handling a number of tasks (act 702).

FIG. 8 is a flowchart illustrating an exemplary process which may be performed by the processing device while performing act 702. First, the processing device may read or obtain configuration information to determine which applications handle files with certain file extensions (act 802). The processing device may obtain the configuration information from a registry, from a policy or from elsewhere to determine applications associated with certain file extensions and corresponding icons associated with the applications. For example, the configuration information may indicate that a file extension of .doc is associated with a word processor application, such as, for example, Microsoft Office Word, or that a file extension of .jpg is associated with a photo editing application, such as, for example, Microsoft Office Picture Manager, available from Microsoft Corporation of Redmond, Wash. Next, the processing device may read or obtain the configuration information to determine applications associated with certain protocols and corresponding icons associated with the applications (act 804). In one embodiment, the configuration information may indicate default applications associated with certain protocols. For example, a default application may be associated with a mail to protocol for sending and receiving e-mail messages, such as, for example, Microsoft Outlook®, available from Microsoft Corporation, or another e-mail application. As another example, a default application may be associated with a hypertext transfer protocol (HTTP) for browsing or searching the Internet, such as, for example, Microsoft Internet Explorer®, available from Microsoft Corporation, or another Internet browser application.

The configuration information may be included in a registry or elsewhere. Further, in some embodiments, some configuration information may be located in another area, such as, for example, an area which may include supplemental or other configuration information.

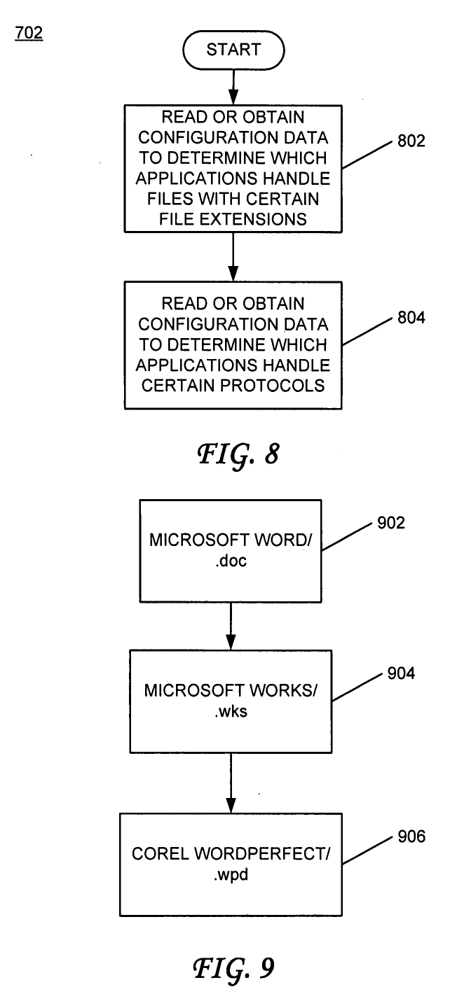

In some embodiments, the configuration information may include a hierarchy of file extensions for one or more types of applications. FIG. 9 illustrates an example of such a hierarchy for word processing applications. For example, the processing device may determine whether an application, such as, for example, Microsoft Office Word, is associated with a file extension, .doc (902). If so, then the application, Microsoft Office Word, may be associated with a task for creating a document. Otherwise, the processing device may determine whether an application, such as, Microsoft Works, available from Microsoft Corporation, is associated with a file extension, .wks (904). If so, then the application, Microsoft Works, may be associated with the task for creating a document. Otherwise, the processing device may determine whether an application, such as, for example, WordPerfect®, available from Corel Corp. with an office in Eden Prairie, Minn., is associated with a file extension, .wpd (906). If so, then the application, WordPerfect® may be associated with the task for creating a document. Thus, in this example, an application for executing a task may be determined by searching a hierarchy of file extensions and using a first available application associated with one of the file extensions. In other words, once an application associated with a file extension in the hierarchy is found, the remainder of the hierarchy may not be searched.

The hierarchy shown in FIG. 9 is only exemplary. In another embodiment, the order of file extensions in the hierarchy may be different or may include other file extensions. Further, other hierarchies of file extensions may pertain to other applications other than word processors.

In other embodiments, the configuration information may include predefined direct access information for executing a particular application to perform a specific task.

Returning to the flowchart of FIG. 7, after automatically examining the configuration information and determining applications for handling a number of tasks and corresponding icons, the processing device may present or display categories of tasks as UI elements on a display screen (act 704), such as illustrated by, for example, exemplary display 200 of FIG. 2. In one embodiment, the processing device may provide audio to a user during act 704. For example, the processing device may describe the UI elements using sound, such as generated speech or other sound. As previously mentioned, the displayed UI elements may be circular or orb-shaped and may be displayed in an approximate circular configuration displayed at about a middle portion of a display screen. Further, a background portion of the display screen may be dimmed to focus a user's attention on the UI elements.

Next, the processing device may receive a selection of a category from a user (act 706). A user may select one of the category-focused UI elements corresponding to a desired task by using a pointing device, such as, for example, a computer mouse, a touchpad, electronics stylus or a user's finger on a touch screen, or other device.

After selection of one of the category-focused UI elements, the processing device may cause one or more task-focused UI elements, corresponding to the selected one of the category-focused UI elements, to be presented or displayed (act 708). In one embodiment, the processing device may provide audio to a user during act 708. For example, the processing device may describe the UI elements using sound, such as generated speech or other sound. As mentioned previously, the one or more displayed task-focused UI elements may be circular or orb-shaped and may be displayed in an approximate circular configuration about a middle portion of a display screen. In other embodiments, the task-focused UI elements may have a shape other than circular or orb-shaped. Each of the task-focused UI elements may include text describing a task, which a user may perform using the processing device. FIGS. 3-6B show examples of task-focused UI elements.

Next, the processing device may receive the user's selection of one of the task-focused UI elements corresponding to a desired task (act 710). The user may select one of the task-focused UI elements corresponding to a desired task by using a pointing device, such as, for example, a computer mouse, a touchpad, an electronic stylus or a user's finger on a touch screen, or other device. Upon selection of one of the task-focused UI elements, the task-focused UI elements may be minimized by the processing device and a minimized representation of the UI elements may be moved to a portion of the display screen near a user interface element used by more experienced users, as described previously (act 712). The processing device may then execute an application associated with the selected one of the task-focused UI elements (act 714).

The flowchart illustrated by FIG. 7 shows an exemplary process. In other embodiments, an order of execution of the acts may differ and other or different acts may be performed. For example, instead of displaying UI elements corresponding to categories of tasks after startup, the processing device may display task-focused UI elements for commonly executed tasks, such as, create a document, browse Internet, open e-mail, or other commonly executed tasks. Further, in such an implementation a selectable UI element for displaying category-focused UI elements may be displayed, such that, when a user selects the selectable UI element, category-focused UI elements may be displayed as described with respect to FIG. 2.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

We claim as our invention:

1. A method for providing a task-focused user interface for a processing device, the method comprising:
automatically examining configuration information of the processing device to determine configured applications for a plurality of tasks, at least one of the determined configured applications includes an application for handling an Internet browsing protocol or an application for handling an e-mail protocol;
displaying the task-focused user interface including a plurality of selectable user interface elements based, at least in part, on a result of the examining of the configuration information, each of the plurality of user interface elements including a description of a corresponding task;
receiving a selection of one of the user interface elements; and
executing the configured one of the default applications corresponding to the selected one of the user interface elements.

2. The method of claim 1, further comprising:
dimming a background of a display on which the task-focused graphical user interface is presented.

3. The method of claim 1, wherein the automatic examining of the configuration information of the processing device further comprises:
determining an application for handling files having a specific file extension.

4. The method of claim 1, wherein the automatic examining of the configuration information of the processing device further comprises:
determining an application for executing a task by searching a hierarchy of file extensions and using a first available application associated with one of the file extensions.

5. The method of claim 1, wherein each of the plurality of user interface elements includes an icon indicative of a respective task.

6. The method of claim 1, wherein the displaying of the task-focused user interface further comprises displaying the task-focused user interface with 3-dimensional effects.

7. The method of claim 1, further comprising:
displaying a second plurality of selectable user interface elements based, at least in part, on a result of the examining of the configuration information, each of the second plurality of user interface elements including displayable text describing a category of tasks;
receiving a selection of one of the second plurality of user interface elements; and
displaying at least one of the selectable user interface elements corresponding to the category of tasks of the selected one of the second plurality of user interface elements, each of the at least one of the displayed selectable user interface elements including displayable text describing a corresponding task.

8. A processing device comprising:
at least one processor;
a bus; and
a memory including data and instructions for the at least one processor, the at least one processor being arranged to access the memory via the bus connecting the memory with the at least one processor, the memory comprising:
instructions for automatically determining configured applications for a plurality of tasks from configuration information of the processing device, and
instructions for displaying at least one task-focused user interface element corresponding to a desired category of tasks, each of the at least one displayed task-focused user interface element being associated with a corresponding one of the automatically determined applications and each of the at least one displayed task-focused user interface including a description of a corresponding task.

9. The processing device of claim 8, wherein the memory further comprises:
instructions for receiving a selection of one of the at least one task-focused user interface element, and
instructions for executing one of the configured applications corresponding to the selected one of the at least one task-focused user interface element.

10. The processing device of claim 8, wherein the memory further comprises:
instructions for minimizing a graphical user interface including the displayed at least one task-focused user interface element, after receiving a selection of one of the at least one task-focused user interface element, and
moving a representation of the minimized graphical user interface to a portion of a display having an interface for experienced users of the processing device.

11. The processing device of claim 8, wherein the memory further comprises:
instructions for moving at least a portion of the displayed at least one task-focused user interface element toward a pointer as the pointer is moved closer to at least a portion of the displayed at least one task-focused user interface element on a display screen.

12. The processing device of claim 8, wherein the instructions for automatically determining configured applications for a plurality of tasks from configuration information of the processing device further comprise:
instructions for determining an application by searching a hierarchy of file extensions and using a first available application associated with one of the file extensions.

13. The processing device of claim 8, wherein the memory further comprises:
instructions for determining an application to execute a task based on predefined direct access information for the task.

14. The processing device of claim 8, wherein the memory further comprises:
instructions for generating sound to describe the displayed at least one task-focused user interface element.

15. The processing device of claim 8, wherein the instructions for automatically determining configured applications for a plurality of tasks from configuration information of the processing device further comprise:
instructions for determining an application for handling at least one of an Internet browsing protocol or an e-mail protocol.

16. A tangible machine-readable medium having instructions recorded thereon for at least one processor, the tangible machine-readable medium comprising:
instructions for automatically examining configuration information to determine configured applications for handling a plurality of tasks;
instructions for displaying a user interface including a plurality of selectable orb-shaped user interface elements based, at least in part, on a result of automatically examining the configuration information, each of the plurality of selectable orb-shaped user interface elements representing a corresponding task and including a description of the corresponding task;
instructions for receiving a selection of one of the plurality of orb-shaped user interface elements; and
instructions for minimizing the user interface after receiving a selection of one of the plurality of orb-shaped user interface elements and moving a representation of the minimized user interface to a portion of a display having an interface for experienced users.

17. The tangible machine-readable medium of claim 16, further comprising:
instructions for dimming a background portion of the display.

18. The tangible machine-readable medium of claim 16, further comprising:
instructions for displaying the plurality of selectable orb-shaped user interface elements in a circular configuration on the display.

19. The tangible machine-readable medium of claim 16, wherein the instructions for automatically examining configuration information to determine configured applications for handling a plurality of tasks further comprise:
instructions for determining an application for handling a particular task by searching a hierarchy of file extensions and using a first available application associated with one of the file extensions.

20. The tangible machine-readable medium of claim 16, wherein the instructions for automatically examining configuration information to determine configured applications for handling a plurality of tasks further comprise:
instructions for accessing supplemental configuration information to determine an application for handling a specific protocol.
